(19) United States
(12) Patent Application Publication
(10) Pub. No.: US 2010/0188713 A1
(43) Pub. Date: Jul. 29, 2010

(54) SCAN IMAGE MANAGEMENT APPARATUS AND METHOD AND COMPUTER-READABLE MEDIUM THEREOF

(75) Inventors: Kazuhiro Ogura, Kanagawa-ken (JP); Shinji Makishima, Tokyo (JP); Akihiro Mizutani, Kanagawa-ken (JP); Toshihiro Ida, Tokyo (JP); Yusuke Hamada, Saitama-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/693,003

(22) Filed: Jan. 25, 2010

Related U.S. Application Data
(60) Provisional application No. 61/147,303, filed on Jan. 26, 2009.

(51) Int. Cl. G06F 12/14; H04N 1/04

(52) U.S. Cl. 358/474; 711/103; 711/154; 711/E12.091

(57) ABSTRACT

A scan image management apparatus configured to manage scan image data acquired by scanning an original document, the scan image management apparatus includes: an ID-information acquiring unit configured to acquire, with a CPU, ID information of a portable recording medium recorded in the portable recording medium; and a use-information recording unit configured to record, with the CPU, the ID information acquired by the ID-information acquiring unit and information for specifying an original document, which is a reading source of scan image data that should be recorded in the portable recording medium, which is an acquisition source of the ID information, in association with each other.

### CROSS-REFERENCE TO RELATED APPLICATION

This application is based upon and claims the benefit of priority from U.S. provisional application No. 61/147303, filed on Jan. 26, 2009, the entire contents of each of which are incorporated herein by reference.

### TECHNICAL FIELD

This specification relates to a technique for storing scanned data in a removable medium such as a USB flash drive in an image processing apparatus, and, more particularly to a technique for managing a storage destination of data.

### BACKGROUND

In the past, processing called Scan to USB for storing image data, which is read by an image reading apparatus such as an MFP or a scanner, in a portable recording medium (a removable medium) such as a USB flash drive (a flash memory) is performed.

The Scan to USE is convenient because image data acquired by reading an original such as a document can be directly recorded in the portable recording medium without being transmitted via a network or the like.

On the other hand, if the Scan to USB can be freely performed, it is difficult to prevent the document from flowing out. Specifically, if a scan image is stored in a USB memory by the Scan to USB processing, unlike storage of data in a predetermined directory via the network, it is difficult to specify a storage destination of the data. Therefore, if the image data is once stored on the outside by the Scan to USB processing, the presence of the data cannot be tracked. Such impossibility of tracking of the document particularly poses a problem when a confidential document is included in an original document to be read.

### SUMMARY

This specification relates to a scan image management apparatus configured to manage scan image data acquired by scanning an original document, the scan image management apparatus including: an ID-information acquiring unit configured to acquire, with a CPU, ID information of a portable recording medium recorded in the portable recording medium; and a use-information recording unit configured to record, with the CPU, the ID information acquired by the ID-information acquiring unit and information for specifying an original document, which is a reading source of scan image data that should be recorded in the portable recording medium, which is an acquisition source of the ID information, in association with each other.

This specification relates to a scan image management method for managing scan image data acquired by scanning an original document, the scan image management method including: acquiring, with a CPU, ID information of a portable recording medium recorded in the portable recording medium; and recording, with the CPU, the acquired ID information and information for specifying an original document, which is a reading source of scan image data that should be recorded in the portable recording medium, which is an acquisition source of the ID information, in association with each other.

This specification relates to a computer-readable recording medium having recorded thereon a scan image management program for causing a computer to execute processing for managing scan image data acquired by scanning an original document, the scan image management program causing the computer to execute processing for: acquiring ID information of a portable recording medium recorded in the portable recording medium; and recording the acquired ID information and information for specifying an original document, which is a reading source of scan image data that should be recorded in the portable recording medium, which is an acquisition source of the ID information, in association with each other.

### DESCRIPTION OF THE DRAWINGS

FIG. 1 is a system diagram for explaining a scan image management system according to an embodiment of the present invention;

FIG. 2 is a functional block diagram of an MFP for explaining a function of granting ID information to a USB memory connected to the MFP;

FIG. 3 is a diagram of an example of a file structure of a USB memory for storing ID information granted by ID information grant processing by an ID-information granting unit;

FIG. 4 is a diagram of an example of data in which ID information of USE memories and information such as user Ins are stored in association with each other in a memory-ID-information managing unit;

FIG. 5 is a functional block diagram for explaining Scan to USB processing by the MFP;

FIG. 6 is a functional block diagram of a management server;

FIG. 7 is a diagram of an example of information managed in a management DB stored in the management server;

FIG. 8 is a flowchart for explaining a flow of the ID information grant processing for granting ID information to the USB memory in the MFP;

FIG. 9 is a flowchart for explaining a flow of the Scan to USE processing executed by the MFP;

FIG. 10 is a flowchart for explaining a flow of processing by the management server for acquiring a use information file and storing the use information file in the management DB;

FIG. 11 is a system diagram for explaining a scan image management system according to another embodiment of the present invention; and

FIG. 12 is a diagram of a list of invalidated ID information.

### DETAILED DESCRIPTION

Embodiments of the present invention are explained below with reference to the accompanying drawings.

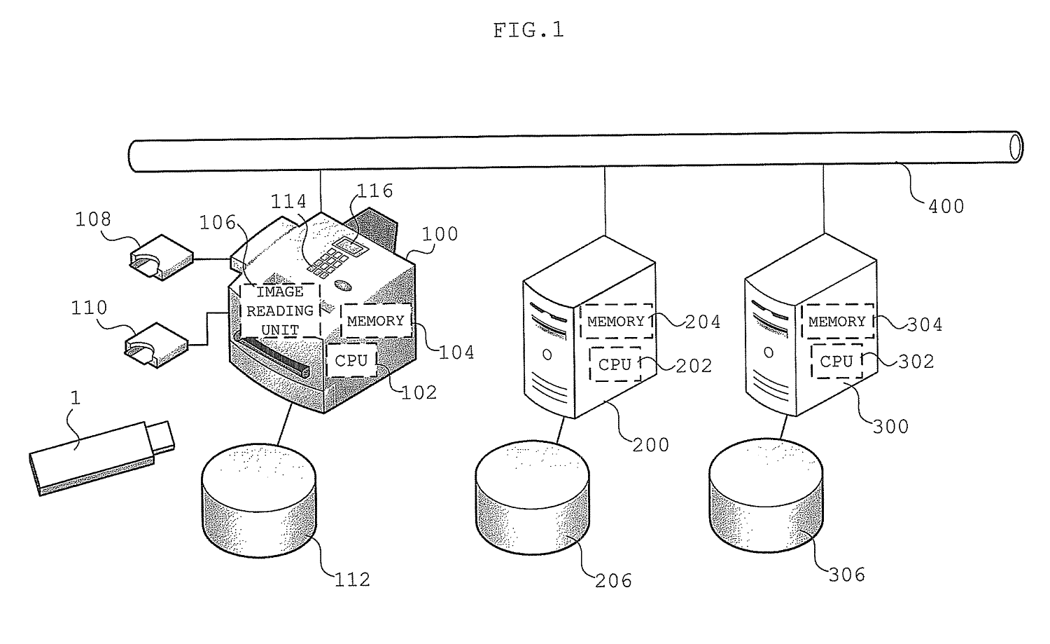

FIG. 1 is a system diagram for explaining a system including a management server 200 functioning as a scan image management apparatus according to an embodiment of the present invention.

The system according to this embodiment includes an MFP (Multifunction Peripheral) 100 configured to perform, for example, scanning of an original document, the management server 200 configured to store information for enabling tracking of a scan image stored in a portable recording medium (a removable medium), and a user authentication server 300 configured to store information for performing user authentication. The MFP 100, the management server 200, and the authentication server 300 are connected via a network 400.

In performing so-called Scan to USB processing for storing, in a USB memory 1 as a portable recording medium, image data acquired by scanning an original document in the MFP 100, the system determines, on the basis of ID information recorded in the USB memory 1 in advance, whether the Scan to USB processing should be permitted. If the Scan to USE processing is permitted, the system stores image data in the USB memory 1 according to the Scan to USB processing.

In the system, when the image data is stored in the USB memory 1, ID information for specifying the USB memory 1, which is a storage destination of the image data, and information for specifying an original document, which is an acquisition source (a reading source) of the image data stored in the USB memory 1, are stored in the management server 200 in association with each other. According to the processing explained above, it is possible to separately authenticate the USB memory 1 and determine whether the Scan to USB processing should be permitted. Further, it is possible to track the storage destination of the image data by the Scan to USB processing.

The “Scan to USB processing” refers to processing for connecting a portable recording medium (a removable medium) such as a USB memory to an MFP, a scanner, or the like and directly storing image data acquired by reading an original document in the connected portable recording medium.

In this embodiment, the USB memory is explained as an example of the portable recording medium. However, the portable recording medium is not limited to the USB memory and may be any portable recording medium as long as the portable recording medium is connected to the MFP or the like and can record image data acquired by scanning in the MFP or the like. Various removable media such as a hard disk drive, a memory card, a floppy disk, an MO, and a CD-R can be applied in the same manner. The connection to the MFP is not limited to the USB standard. Other connection standards such as IEEE 1394 can also be used.

The configurations of the apparatuses included in the system according to this embodiment are explained below.

The MFP 100 has plural functions such as a scan function, a printer function, a copy function, and a facsimile function. The MFP 100 includes a CPU 102, a memory 104, and an image reading unit 106. The MFP 100 according to the embodiment further includes a user authenticating unit 108, a USB connecting unit 110, and a USE-memory-ID-information managing unit 112. Besides, the MFP 100 includes an operation input unit 114 and a display unit 116.

The user authenticating unit 108 is an apparatus for acquiring information necessary for authentication in order to perform authentication processing when a user uses the MFP 100. When authentication is performed by using an ID card having recorded thereon ID information of the user (the ID information of the user is hereinafter also referred to as “user ID”) and the like, the user authenticating unit 108 includes a card reading device. When the user inputs the ID information and performs authentication, the user authenticating unit 108 includes an operation input device such as a keyboard or a touch panel. The operation input unit 114 and the like included in the MFP 100 may be used as these devices. When user authentication is performed, the user authenticating unit 108 determines, for example, whether the user ID acquired by the user authenticating unit 108 coincides with a user ID recorded in the user authentication server 300 and determines, for example, whether the user may use the MFP 100.

The USB connecting unit 110 is a member for connecting the USB memory 1 to the MFP 1 when the Scan to USB processing is performed by the MFP 100.

The USE-memory-ID-information managing unit (hereinafter referred to as “memory-ID-information managing unit”) 112 records and manages ID information granted to the USE memory 1 by processing explained later in association with a user ID and the like. When the MFP 100 determines whether the Scan to USB processing is permitted for the USB memory 1, the MFP 100 performs the determination on the basis of the ID information recorded in the memory-ID-information managing unit 112.

The CPU 102 controls, for example, processing for granting ID information to the USB memory 1, processing concerning the management of the ID information, and determination processing for permitting the Scan to USB processing for the USB memory 1. Besides, the CPU 102 controls various kinds of processing in the MFP 100 such as image reading processing and image forming processing.

The memory 104 stores computer programs used for the various kinds of processing executed by the CPU 102. The memory 104 can include a RAM (Random Access Memory), a ROM (Read Only Memory), a DRAM (Dynamic Random Access Memory), a SRAM (Static Random Access Memory), or a VRAM (Video RAM)

The image reading unit 106 is a general image reading device included in an MFP, a copying machine, or a scanner. The image reading unit 106 is used when an original document is scanned or copied by the MFP 100.

The operation input unit 114 is a device for performing operation in using various functions of the MFP 100. The operation input unit 114 can include a keyboard or a touch panel. The display unit 116 is a device configured to display an operation state and the like of the MFP 100. The display unit 116 can include an LCD (Liquid Crystal Display), an EL (Electronic Luminescence), or a PDP (Plasma Display Panel).

The management server 200 is an apparatus configured to store various states of use and the like of the MFP 100. In this embodiment, as explained above, when the Scan to USB processing is performed by the MFP 100, the management server 200 acquires from the MFP 100, for example, the ID information for specifying the USE memory 1, which is a storage destination of image data acquired by scanning and the information for specifying an original document, which is an acquisition source of the image data stored in the USB memory 1. The management server 200 includes a management DB 206 in which these kinds of information are stored in association with each other. Consequently, when the Scan to USB processing is performed, it is possible to specify which document is stored in which USB memory.

The management server 200 includes a CPU 202 and a memory 204. When the Scan to USB processing is executed, as explained above, the CPU 202 performs, for example, the processing for acquiring the ID information and the information for specifying an original document and registering both the kinds of information in the management DB 206 in association with each other. The memory 204 stores a computer program to be executed by the CPU 202. Like the MFP 100, the memory 204 can include a RAM (Random Access Memory), a ROM (Read Only Memory), a DRAM (Dynamic Random Access Memory), a SRAM (Static Random Access Memory), or a VRAM (Video RAM).

The user authentication server 300 includes a user authentication DB 306 in which, for example, user IDs and authority information for deciding functions and the like of the MFP 100 usable by users having the user IDs are stored in association with each other. The user authentication server 300 further includes a CPU 302 and a memory 304.

The network 400 can include the Internet, a LAN (Local Area Network), or a WAN (Wide Area Network)

A function of the MFP 100 for granting ID information to the USB memory 1 is explained below.

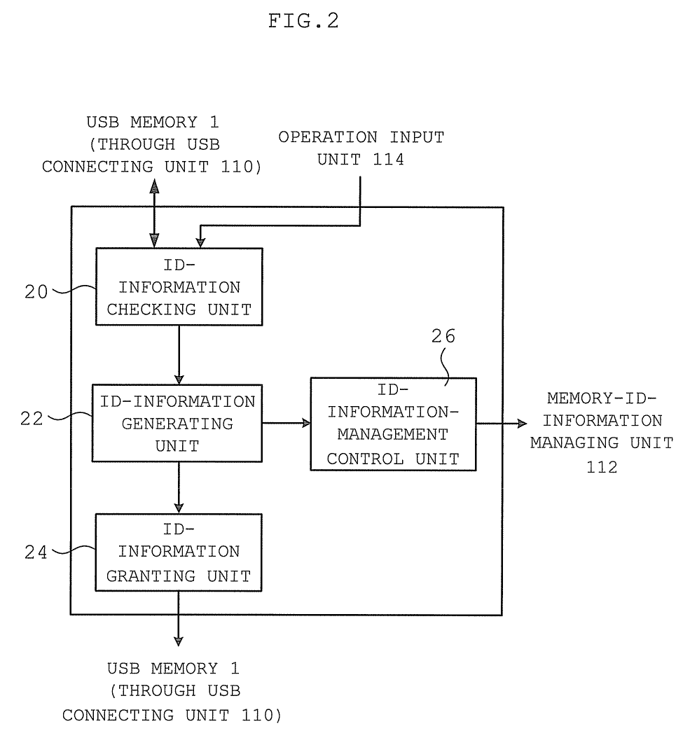

FIG. 2 is a functional block diagram for explaining the function of the MFP 100 for granting ID information to the USB memory 1 connected to the MFP 100.

The MFP 100 includes an ID-information checking unit 20, an ID-information generating unit 22, an ID-information granting unit 24, and an ID-information-management control unit 26.

When the USB memory 1 is connected to the USE connecting unit 110 and execution of processing for granting ID information to the USE memory 1 is instructed from the operation input unit 114, the ID-information checking unit 20 checks whether the ID information is stored in the USB memory 1. If it is determined that the ID information is not stored, the ID-information generating unit 22 performs processing for generating ID information to be granted to the USB memory 1.

The ID information generated by the ID-information generating unit 22 is unique ID information with which the USB memory 1 can be specified. The ID information can be, for example, a character string formed by combining a MAC address (Media Access Control address) of the MFP 100, which is generally a unique character string, and a number indicating the order of granting an ID in the MFP 100. Specifically, when the MAC address of the MFP 100 is “ABCDEF000123” and the ID information is granted to the USB memory 1 by the MFP 100 one hundred fiftieth, the ID information to be granted to the USB memory 1 can be, for example, “ABCDEF00012300150”. It goes without saying that any other character string may be used as the ID information as long as the character string is a unique character string.

The ID-information granting unit 24 performs processing for causing the USE memory 1 to store, via the USB connecting unit 110, the ID information generated by the ID-information generating unit 22.

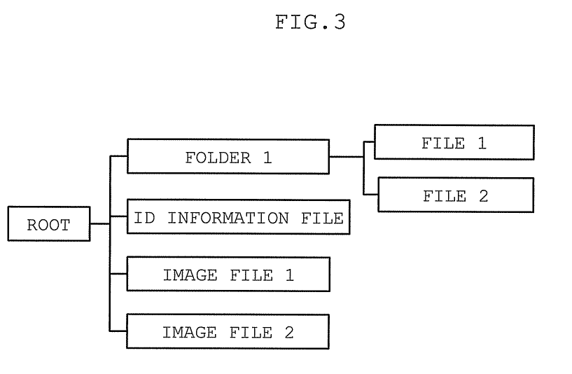

FIG. 3 is a diagram of an example of a file structure of the USE memory 1 in which the ID information granted by the ID information grant processing by the ID-information granting unit 24 is stored. The USB memory 1 stores files in the tree structure. Under a root directory, a folder 1, an image file 1, and an image file 2 are stored. A file of the ID information granted to the USB memory 1 is also stored under the root directory.

When the ID information stored in the USB memory 1 is copied or moved, the USB memory 1 cannot be specified. Therefore, the ID information is desirably stored with the copying and the movement thereof restricted. Therefore, for example, it is desirable to invisualize and store the ID information, generate an invisible partition in the USE memory 1 and store the ID information in an area separate from other files, set an access authority for the ID information (e.g., read-only permission in permission setting) to prohibit a user from accessing the ID information, or encrypt the ID information. A file of the ID information may be protected to invalidate the ID information stored in the USB memory 1 when the ID information is moved to other places.

The ID-information-management control unit 26 performs processing for storing, in the memory-ID-information managing unit 112, the ID information, which is generated by the ID-information generating unit 22 and granted to the USE memory 1 by the ID-information granting unit 24, in association with information such as the user ID for specifying the user.

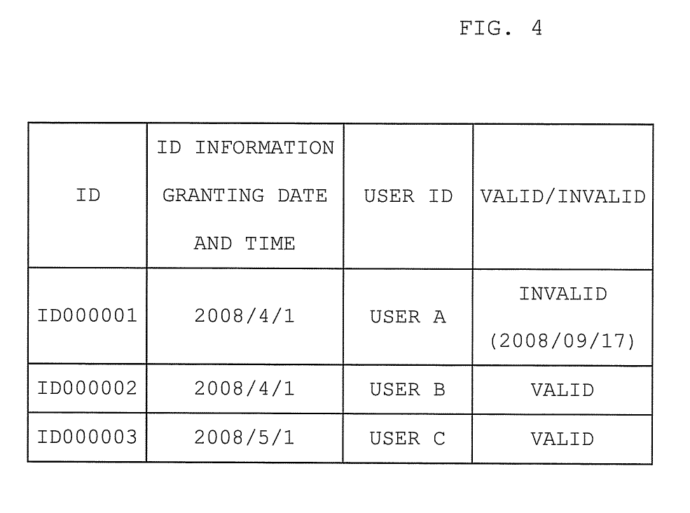

FIG. 4 is a diagram of an example of data in which ID information of USB memories and information such as user IDs are stored in association with each other in the memory-ID-information managing unit 112. As shown in FIG. 4, in the memory-ID-information managing unit 112, for example, the ID information (e.g., ID000001) granted to the USB memory 1, date and time (Apr. 1, 2008) when the ID information is granted, a user ID (user A) of the user of the USB memory 1 who requests the granting of the ID information, and the like are stored in association with one another. The MFP 100 acquires the user ID from an ID card of the user, for example, in user authentication in the MFP 100.

As shown in FIG. 4, in addition to these kinds of information, it is possible to register, for each of IDs of the USB memories, whether the ID is valid or invalid. For example, when the USB memory 1 with the ID “ID000001” is lost, “ID000001” can be set “invalid” to prohibit the Scam to USB processing performed by using the USE memory 1. In this case, in the scan to USB processing explained later, even if the USB memory 1 is connected to the MFP 100, the MFP 100 does not perform the Scan to USB processing. When the user desires to invalidate an ID or validate an invalidated ID, the user only has to designate the ID of a USB memory and apply for invalidation or validation from a not-shown computer or the like connected to the MFP 100 including the memory-ID-information managing unit 112 via the network 400.

If the ID-information checking unit 20 determines that the ID information is already stored in the USB memory 1, the ID-information generating unit 22, the ID-information granting unit 24, and the ID-information-management control unit 26 do not execute the respective kinds of processing explained above.

The function of the MFP 100 for executing the Scan to USB processing is explained below.

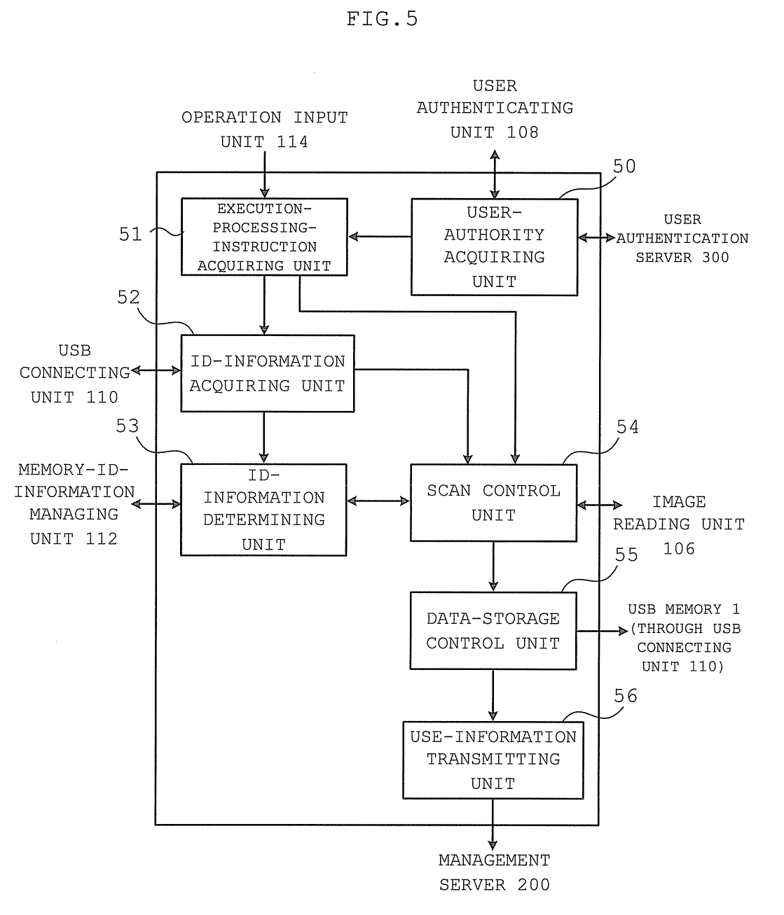

FIG. 5 is a functional block diagram concerning the Scan to USB processing by the MFP 100.

The MFP 100 includes a user-authority acquiring unit 50, an execution-processing-instruction acquiring unit 51, an ID-information acquiring unit 52, an ID-information determining unit 53, a scan control unit 54, a data-storage control unit 55, and a use-information transmitting unit 56.

When user authentication is necessary to use the MFP 100, the user-authority acquiring unit 50 acquires information necessary for authentication such as a user ID from the user authenticating unit 108. Specifically, for example, when user authentication is performed by using an ID card, the user-authority acquiring unit 50 reads the ID card with the user authenticating unit 108 and acquires a user ID. The user-authority acquiring unit 50 acquires, with reference to the user authentication DE 306 of the user authentication server 300, authority in the MFP 100 corresponding to the acquired user ID. The authority is a range of processing and functions usable in the MFP 100. Concerning the Scan to USB processing, for example, authority can be set in such a manner that the Scan to USB processing is “not permitted”, “permitted only when ID information is present in a USE memory”, and “permitted even if ID information is not present”.

The execution-processing-instruction acquiring unit 51 acquires an instruction for processing executed by the MFP 100 according to the operation of the operation input unit 114. In this embodiment, the execution-processing-instruction acquiring unit 51 acquires an operation input for instructing the MFP 100 to perform the Scan to USB processing.

The execution-processing-instruction acquiring unit 51 causes the MFP 100 to execute processing corresponding to user authentication acquired by the user-authentication acquiring unit 50. Specifically, when the Scan to USB processing is not permitted, the execution-processing-instruction acquiring unit 51 does not cause the MFP 100 to execute the Scan to USB processing and executes processing for, for example, causing the display unit 116 to display an indication that the Scan to USB processing is not executed. When the user authentication permits the Scan to USB processing only when the USB memory 1 has ID information, the execution-processing-instruction acquiring unit 51 causes the ID-information acquiring unit 52 to acquire the ID information of the USE memory 1. When the user authentication permits the Scan to USB processing even if ID information is not present, the execution-processing-instruction acquiring unit 51 causes the scan control unit 54 to execute scan processing.

When ID information is required to perform the Scan to USE processing, the ID-information acquiring unit 52 acquires ID information from the USB memory 1 connected to the USB connecting unit 110.

The ID-information determining unit 53 determines, with reference to the memory-ID-information managing unit 112, whether the ID information acquired by the ID-information acquiring unit 52 is registered ID information. When the ID information is registered, the ID-information determining unit 53 determines whether the ID information is valid.

When the Scan to USB processing is permitted even if ID information is not present or when ID information of the USB memory 1 is required for the Scan to USB processing and the acquired ID information is valid, the scan control unit 54 causes the image reading unit 106 to execute scan processing for an original document.

The data-storage control unit 55 performs processing for causing the USB memory 1 to store image data acquired by the reading of the original document by the image reading unit 106.

When the image data is stored in the USB memory 1, the use-information transmitting unit 56 transmits, to the management server 200, a use information file in which, for example, the ID information of the USB memory 1, which is a storage destination of the image data, and information for specifying the original document, which is an acquisition source of the stored image data, are stored in association with each other. Examples of the information for specifying the original document, which is an acquisition source of the image data, include the image data, text data acquired by subjecting the image data to OCR processing, and a management number of a document obtained by reading a QR code or the like printed on the original document.

The functions of the MFP 100 shown in FIGS. 2 and 5 explained above are realized by the CPU 102 executing an ID information granting program and a Scan to USB processing program stored in the memory 104.

Processing by the management server 200 for storing, in the management DE 206, a use information file in which image data transmitted from the MFP 100 and information for specifying an original document corresponding to the image data are associated with each other is explained below.

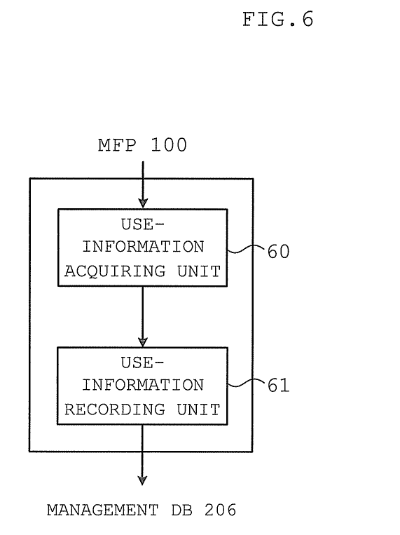

FIG. 6 is a functional block diagram of the management server 200.

The management server 200 includes a use-information acquiring unit 60 and a use-information storing unit 61.

The use-information acquiring unit 60 acquires the use information file transmitted from the MFP 100.

The use-information recording unit 61 records the acquired use information file in the management DE 206.

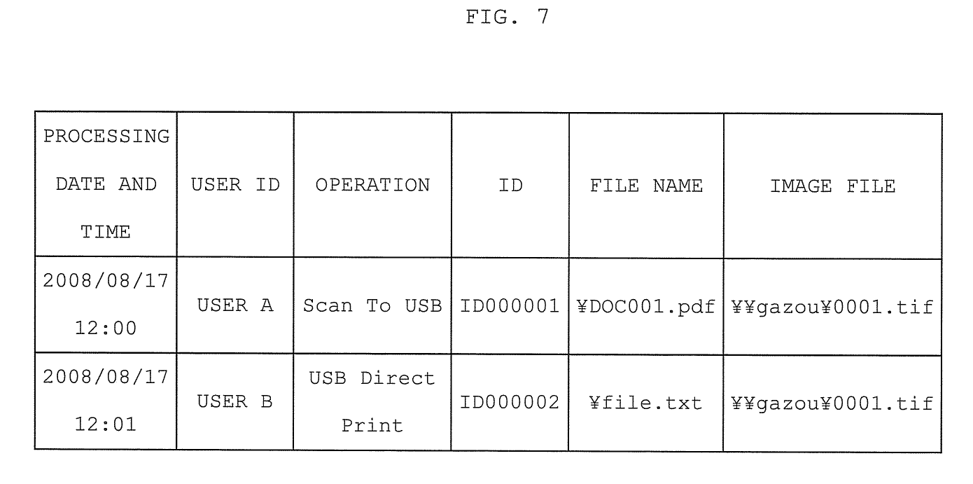

Information registered in the management DE 206 of the management server 200 is explained. FIG. 7 is a diagram of an example of information managed in the management DB 206.

As shown in FIG. 7, in the management DB 206, ID information of the USB memory 1, which is a storage destination of image data by the Scan to USB processing, and an image file (in FIG. 7, a TIFF file) as information for specifying an original document, which is an acquisition source of the image data, are registered in association with each other. Besides, user IDs acquired by user authentication, date and times when the Scan to USB processing is performed, file names of the image data, and the like are associated with the ID information. According to the information recorded in the management DB 206, for example, it is possible to specify the original document from the image file and specify a USB memory from the ID information. Therefore, it is possible to track in which portable recording medium a certain original document is recorded.

With the system according to this embodiment explained above, when the Scan to USB processing is performed in the MFP 100, it is possible to manage information for specifying an original document, which is an acquisition source of image data acquired by the Scan to USB processing, and ID information of a USB memory for specifying a storage destination of the acquired image data in association with each other. Therefore, even when image data is stored in a portable recording medium such as a USB memory by the Scan to USB processing, it is possible to track scan image data of which document is stored in which portable recording medium and perform document management with a high security level.

It is possible to set permission and prohibition of the Scan to USE processing using ID information uniquely granted for each of portable recording media. Therefore, it is possible to separately set a portable recording medium to which the Scan to USB processing can be applied and perform management of the Scan to USB processing with a high degree of freedom.

Flows of the processing in the MFP 100 and the processing in the management server 200 are explained below.

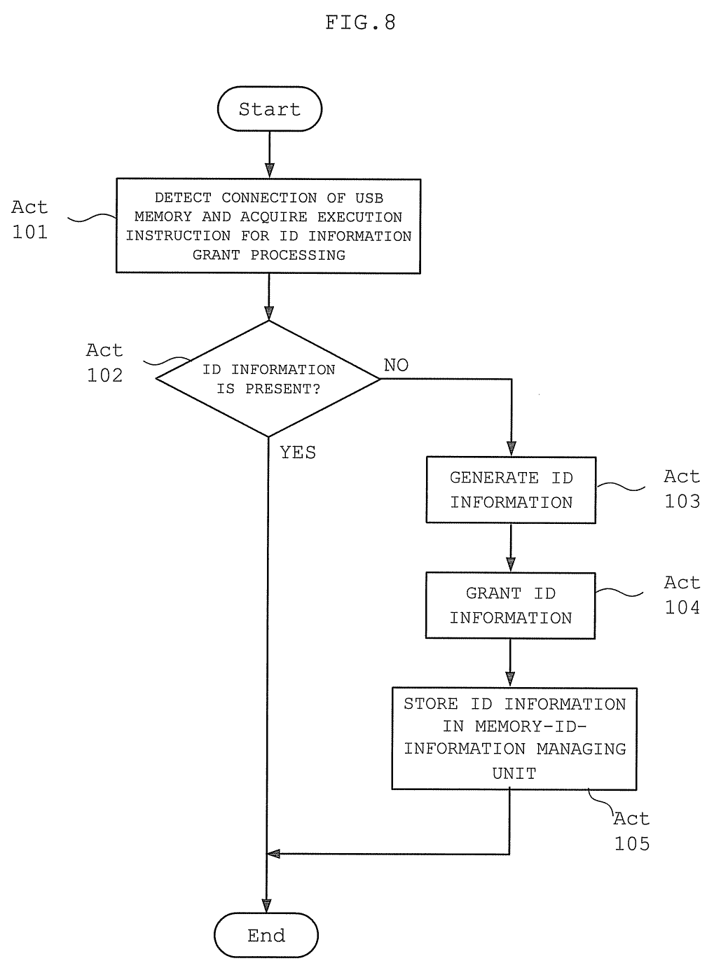

First, a flow of the ID information grant processing for the USB memory 1 in the MFP 100 is explained with reference to FIG. 8.

FIG. 8 is a flowchart for explaining the flow of the ID information grant processing for the USB memory 1 in the MFP 100. The ID information grant processing is performed by using the CPU 102 (a hardware resource). In Act 101, when the USB memory 1 is connected to the USB connecting unit 110 and execution of processing for granting ID information to the USB memory 1 is instructed from the operation input unit 114, the ID-information checking unit 20 detects the connection of the USE memory 1 and acquires the execution instruction for the ID information grant processing.

In Act 102, the ID-information checking unit 20 checks whether ID information is already stored in the USB memory 1.

If the ID-information checking unit 20 determines in Act 102 that ID information is not stored, in Act 103, the ID-information generating unit 22 generates ID information to be granted to the USB memory 1. The ID information needs to be a unique ID as explained above. For example, the ID information can be a character string formed by combining a MAC address of the MFP 100 and a serial number indicating the order of granting ID information in the MFP 100.

In Act 104, the ID-information granting unit 24 grants the ID information generated by the ID-information generating unit 22 in Act 103 to the USB memory 1. Specifically, the ID-information granting unit 24 performs processing for storing the ID information in the USB memory 1. However, as explained above, to prevent the ID information from being copied or moved, the ID-information granting unit 24 may perform processing for invisualizing and storing the ID information, storing the ID information in an invisualized separate area, or invalidating the ID information when the ID information is copied or moved.

In Act 105, the ID-information-management control unit 26 stores the ID information granted to the USB memory 1 in the memory-ID-information managing unit 112 of the MFP 100. Information to be stored is, as explained above with reference to FIG. 4, information in which ID information of USE memories, user IDs, date and times when the ID information is granted, and the like are associated.

The processing for granting ID information to the USB memory 1 ends.

On the other hand, if the ID-information checking unit 20 determines in Act 102 that ID information is already granted to the connected USB memory 1, the ID information grant processing is not performed.

According to the processing explained above, it is possible to grant unique ID information to the USB memory 1.

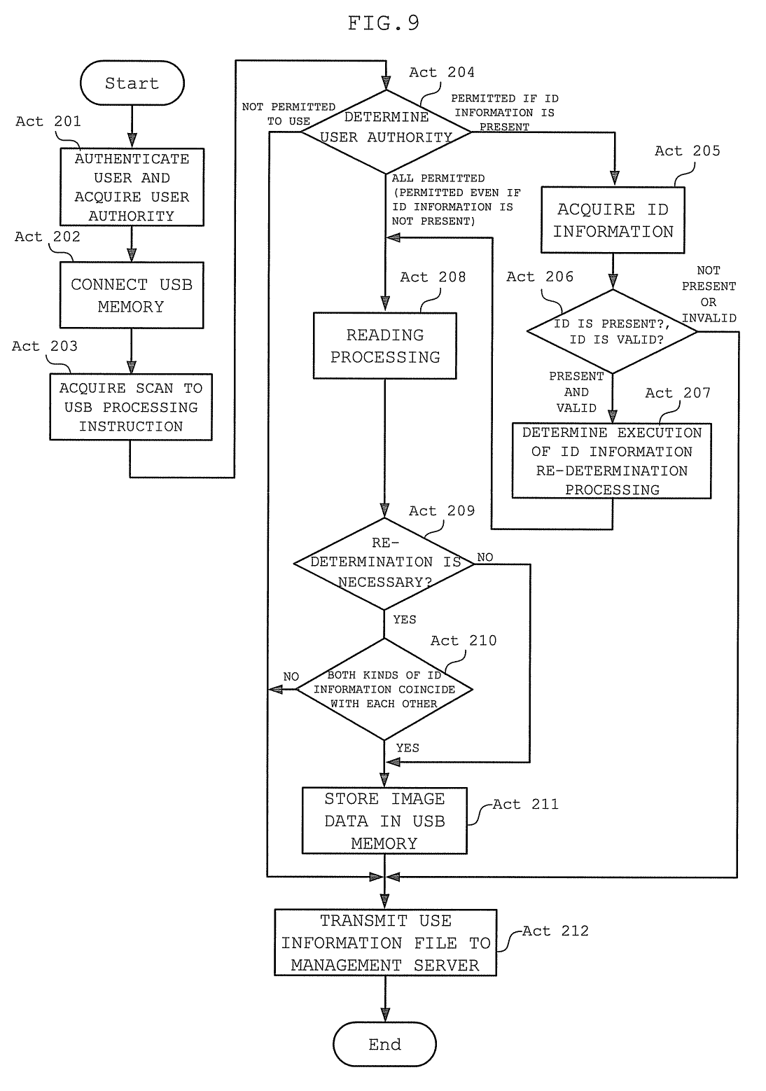

A flow of the Scan to USB processing involving authentication of ID information in the MFP 100 is explained with reference to FIG. 9. The ID information grant processing is performed by using the CPU 102 (a hardware resource).

FIG. 9 is a flowchart for explaining the flow of the Scan to USB processing executed in the MFP 100 according to this embodiment.

First, in Act 201, to perform user authentication for a user to use the MFP 100, the user-authority acquiring unit applies authentication processing to the user authenticating unit 108 to acquire a user ID. For example, when authentication is performed by using an ID card of the user, the user-authority acquiring unit 50 reads and acquires a user ID recorded in the ID card from a card reading device functioning as the user authenticating unit 108. When authentication is performed by inputting a user ID, the user-authority acquiring unit 50 acquires a user ID input from a keyboard or the like functioning as the user authenticating unit 108. The user-authority acquiring unit 50 refers to the user authentication DB 306 of the user authentication server 300 on the basis of the acquired user ID and acquires authority in the MFP 100 corresponding to the user ID.

In Act 202, the user-authority acquiring unit 50 confirms that the USB memory 1 is connected to the connecting unit 110.

In Act 203, the execution-processing-instruction acquiring unit 51 acquires an execution instruction for the Scan to USB processing by the operation input unit 114.

In Act 204, with respect to the user authority acquired by the user-authority acquiring unit 50, the execution-processing-instruction acquiring unit 51 determines whether the Scan to USB processing is “permitted when ID information is present in a USB memory”, “permitted even if ID information is not present”, or “not permitted”.

If the execution-processing-instruction acquiring unit 51 determines in Act 204 that the user authority is “permitted when ID information is present in a USB memory”, in Act 205, the ID-information acquiring unit 52 acquires ID information from the USE memory 1 connected to the USB connecting unit 110.

In Act 206, the ID-information determining unit 53 determines whether ID information is acquired from the USE memory 1. If ID information is acquired, the ID-information determining unit 53 determines, with reference to the memory-ID-information managing unit 112, whether the acquired ID information is valid.

If the ID-information determining unit 53 determines in Act 206 that ID information is acquired and the acquired ID information is valid, in Act 207, the ID-information determining unit 53 records that, when storage of image data acquired by scanning in the USB memory 1 is started, re-determination is executed to determine whether ID information of a USB memory connected to the USB connecting unit 110 coincides with the ID information acquired by the ID-information acquiring unit 52 in Act 205.

In Act 208, the scan control unit 54 causes the image reading unit 106 to execute processing for reading an original document and acquires read image data.

In Act 209, the data-storage control unit 55 functions as a re-determining unit and determines, on the basis of the record concerning necessity of re-determination of the ID information in Act 207, whether re-determination of the ID information of the USB memory 1 is necessary.

If the data-storage control unit 55 determines in Act 209 that the re-determination of the ID information is necessary, in Act 210, the data-storage control unit 55 as the re-determining unit determines whether the ID information of the USB memory 1 connected to the USB connecting unit 110 coincides with the ID information acquired in Act 205.

The re-determination processing in Act 207, Act 209, and Act 210 is performed to check, when image data is stored in a USB memory by the Scan to USB processing, whether the image data is recorded in a USB memory same as the USB memory, the ID information of which is checked in Act 206. Consequently, it is possible to prevent the USB memory from being replaced while data is stored after an ID is checked. Instead of performing the re-determination processing, means for detecting removal of the USB memory is provided and, when the USB memory is removed after ID information is checked, the Scan to USB processing is stopped. This also makes it possible to prevent the replacement of the USB memory.

If the data-storage control unit 55 determines in Act 210 that both the kinds of ID information coincide with each other, in Act 211, the data-storage control unit 55 performs processing for causing the USE memory 1 to store the image data acquired in Act 208.

In Act 212, the use-information transmitting unit 56 transmits, to the management server 200, a use information file of the MFP 100 in which the ID information of the USB memory 1, which is a storage destination of the image data, and information for specifying the original document, which is an acquisition source of the stored image data, are associated with each other and ends processing.

If the ID-information determining unit 53 determines in Act 206 that ID information is not acquired or when the acquired ID information is invalid and when both the kinds of ID information do not coincide with each other in Act 210 (i.e., the USB memory is replaced), the Scan to USB processing is not executed. In Act 212, the use-information transmitting unit 56 transmits use information indicating that the Scan to USB processing is not executed to the management server 200. The use-information transmitting unit 56 may end the Scan to USB processing without transmitting the information indicating that the Scan to USB processing is not executed to the management server 200.

If the user authority acquired by the user-authority acquiring unit 50 is that the Scan to USB processing is “permitted even if ID information is not present” in Act 204, the reading processing in Act 208 is executed. In Act 209, the data-storage control unit 55 determines that the re-determination processing for the ID information is unnecessary. In Act 211, the data-storage control unit 55 performs processing for storing image data acquired by the reading processing in the USB memory 1 without executing the re-determination processing. In Act 212, when necessary, the use-information transmitting unit 56 transmits the use information to the management server 200.

If the user authority acquired in Act 204 is that the Scan to USB processing “is not permitted”, the Scan to USB processing is not performed and the use-information transmitting unit 56 transmits, when necessary, use information indicating that the Scan to USB processing is not executed to the management server 200.

The flow of the Scan to USB processing in the MFP 100 is explained above.

According to the processing, it is possible to separately authenticate a USB memory used for the Scan to USB processing in the MFP 100 and permit or prohibit the Scan to USE processing.

In the flowchart shown in FIG. 9, in the re-determination processing for the ID information in Act 210, it is determined whether the ID information coincides with the ID information acquired in Act 205. However, the re-determination processing is not limited to this. ID information may be simply acquired from the connected USB memory again and, as in Act 206, it may be determined with reference to the memory-ID-information managing unit 112 whether the ID information is valid.

The processing from Act 201 to Act 203 is not limited to the order shown in FIG. 9. The order may be changed or Act 201 to Act 203 may be processed in parallel.

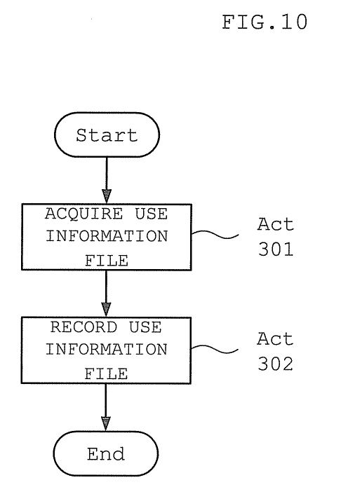

A flow of processing by the management server 200 for storing a use information file transmitted from the MFP 100 in the management DB 206 is explained below with reference to FIG. 10. The ID information grant processing is performed by using the CPU 202 (a hardware resource)

FIG. 10 is a flowchart for explaining a flow of processing by the management server 200 for acquiring a use information file and storing the use information file in the management DB 206.

In Act 301, the use-information acquiring unit 60 of the management server 200 acquires a use information file transmitted from the MFP 100 via the network 400. The use information file is, as explained above, information concerning the Scan to USB processing in which the ID information of the USB memory 1, which is a storage destination of image data, and information for specifying an original document, which is an acquisition source of the stored image data, are associated with each other.

In Act 302, the use-information recording unit 61 records the acquired use information file in the management DB 206.

The above is a flow of processing for registering the use information file transmitted from the MFP 100 in the management DB 206 in the management server 200.

As explained above, with the system according to this embodiment, it is possible to grant unique ID information to the USB memory 1. It is possible to apply, using the unique ID information, authentication processing to the USB memory 1 having the ID information and then store an image acquired by the Scan to USB processing.

According to such Scan to USB processing, it is possible to record and manage ID information of a USB memory and information for specifying an original document, which is an acquisition source of image data acquired by the Scan to USB processing, in association with each other. Therefore, it is possible to surely manage a document and image data obtained by reading the document.

In this embodiment, ID information of a USB memory, which is a data storage destination of the Scan to USB processing, and information for specifying an original document are stored in the management server 200 in association with each other. However, the present invention is not limited to this. As in the management server 200, it is also possible to provide a management DB 120 in the MFP 100 and store ID information and information for specifying an original document in the management DB 120 in association with each other.

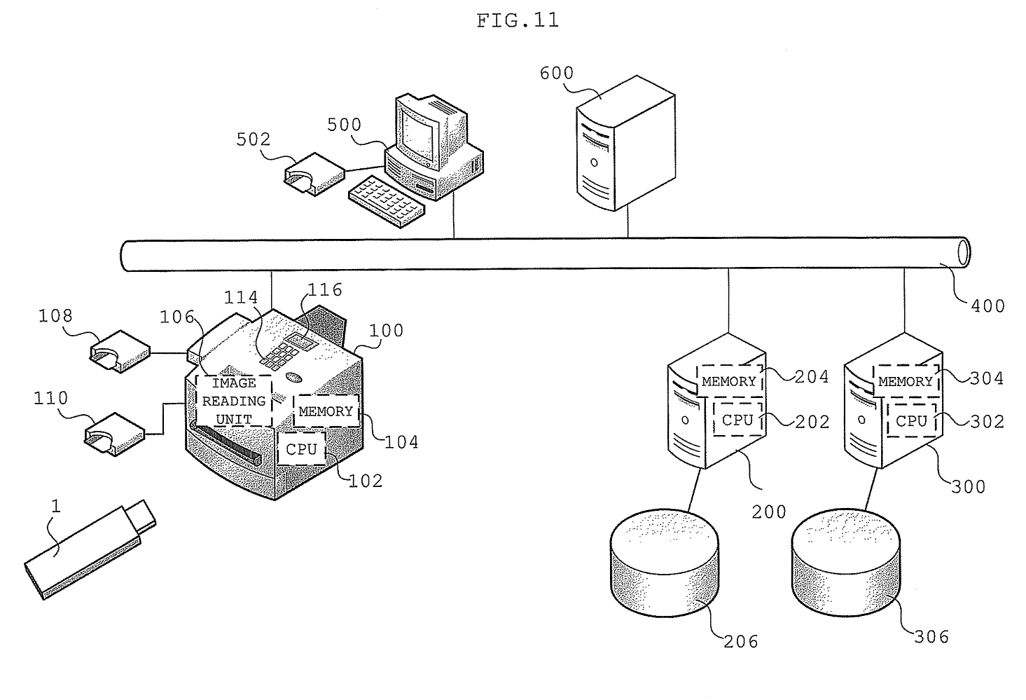

In this embodiment, when ID information is granted to the USB memory 1, the USB memory 1 is connected to the USB connecting unit 110 of the MFP 100 and ID information is generated and stored in the USB memory 1. However, the present invention is not limited to this. For example, as shown in FIG. 11, it is also possible to connect the USE memory 1 to a USB connecting unit 502 of a computer 500 connected to the network 400 and acquire ID information generated by the MFP 100 via the network 400 and stored in the USB memory 1.

In this embodiment, the Scan to USB processing is performed by directly connecting the USB memory 1 to the MFP 100. However, the present invention is not limited to this. For example, as the Scan to USB processing, it is also possible to connect the USB memory 1 to the computer 500 or the like connected to the MFP 100 via the network 400 as shown in FIG. 11 and store image data read by the MFP 100 in the USB memory 1 connected to the computer 500 via the network 400. In this case, as in the embodiment, the MFP 100 acquires ID information from the USB memory 1 via the network 400 and transmits the acquired ID information and information for specifying an original document to the management server 200 and stores these kinds of information in the management server 200 in association with each other. This makes it possible to specify a USB memory, which is a storage destination of the image data.

In this embodiment, the ID information granted to the USB memory 1 is stored in the memory-ID-information managing unit 112 included in the MFP 100. However, the present invention is not limited to this. For example, as shown in FIG. 11, a memory-ID-information management server 600 having the same function as the memory-ID-information managing unit 112 may be separately provided. In this case, when ID information is granted to the USE memory 1 in the MFP 100 (or the computer 500 shown in FIG. 11), the granted ID information is stored in the memory-ID-information management server 600 via the network 400 in association with a user ID and the like. When the memory-ID-information management server 600 is provided instead of the memory-ID-information managing unit 112 in this way, in the Scan to USB processing, the ID-information determining unit 53 of the MFP 100 accesses the memory-ID-information management server 600 via the network 400 and determines whether ID information acquired from a USB memory connected to the MFP 100 is registered ID information.

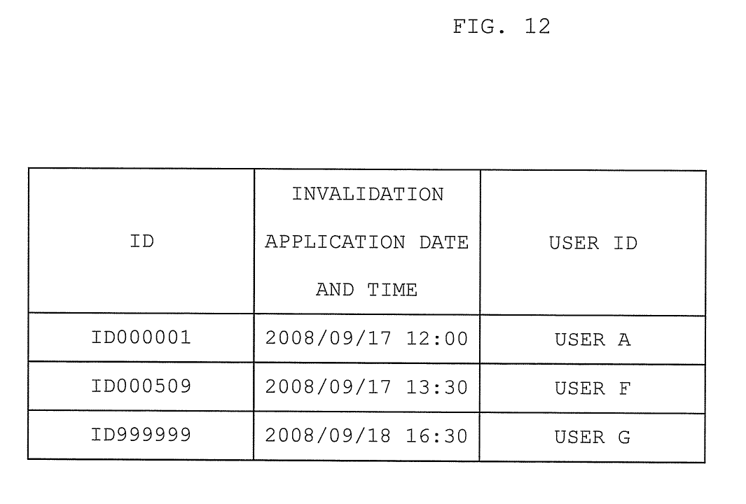

In this embodiment, information concerning validity and invalidity of ID information is stored in the memory-ID-information managing unit 112 (or the memory-ID-information management server 600) in association with the ID information as shown in FIG. 4. However, the present invention is not limited to this. For example, as shown in FIG. 12, a list of invalidated ID information may be separately stored in the ID-information managing unit 112. In this case, for example, in the Scan to USB processing, the invalid ID information list of the memory-ID-information managing unit 112 is referred to and, when ID information of a connected USB memory is present in the invalid ID information list, processing can be performed to prohibit storage of a scan image in the USB memory.

In this embodiment, when the Scan to USB processing is performed, user authority is determined on the basis of a user ID. However, the present invention is not limited to this. It is also possible to start the Scan to USB processing from authentication by ID information of a USB memory without performing authentication processing for a user based on a user ID or the like. Even in this case, ID information, which is a storage destination of image data, and information for specifying an original document, which is an acquisition source of the image data, are stored in the management DB 206 of the management server 200 in association with each other. Therefore, it is possible to track scan data.

In this embodiment, the Scan to USB processing performed by using a USB memory is explained. However, the present invention can also be applied to, for example, processing for connecting the USB memory 1 to the MFP 100 and printing image data stored in the USB memory 1 in the MFP 100. Specifically, when the image data is directly printed from the USB memory 1, ID information is acquired from the USB memory 1, authentication processing for determining, for example, whether the ID information is valid is performed, and the image data is printed. The printed image data and the ID information of the USB memory 1 can be recorded in the management server 200 in association with each other. Specifically, the image data and the ID information are recorded in association with each other as information concerning USB Direct Print like the information of a user B shown in FIG. 7.

The operations in the processing in the apparatuses explained above are realized by causing the CPU 102, the CPU 202, and the CPU 302 to respectively execute computer programs stored in the memory 104 of the MFP 100, the memory 204 of the management server 200, and the memory 304 of the user authentication server 300.

A computer program for causing computers included in the apparatuses to execute the operations can be provided as a scan-image managing program. In this embodiment, the computer program for realizing the function for realizing the present invention is recorded in advance in storage areas provided in the apparatuses. However, the present invention is not limited to this. The same computer program may be downloaded from a network to the apparatuses. The same computer program stored in a computer-readable recording medium may be installed in the apparatuses. The recording medium may be a recording medium of any form as long as the recording medium can store the computer program and can be read by the computer. Specifically, examples of the recording medium include internal storage devices internally mounted in a computer such as a ROM and a RAM, portable recording media such as a CD-ROM, a flexible disk, a DVD disk, a magneto-optical disk, and an IC card, a database for storing a computer program, other computers and databases for the computers, and a transmission medium on a line. The function obtained by installation or download in advance in this way may be a function realized in cooperation with OSs (operating systems) in the apparatuses.

The computer program may be an execution module that is dynamically generated partially or entirely.

The present invention can be carried out in various forms without departing from the spirit or the main characteristic thereof. Therefore, the embodiment described above is only an illustration in every aspect and should not be limitedly interpreted. The scope of the present invention is indicated by the scope of claims and is by no means limited by the text of the specification. Further, all modifications and various improvements, substitutions, and alterations belonging to the scope of equivalents of the scope of claims are within the scope of the present invention.

As explained above, according to the present invention, it is possible to provide a technique for managing, in recording image data acquired by reading an original document in a portable recording medium, a recording destination of the image data such that the recording destination can be specified.

What is claimed is:

1. A scan image management apparatus configured to manage scan image data acquired by scanning an original document, the scan image management apparatus comprising:
an ID-information acquiring unit configured to acquire, with a CPU, ID information of a portable recording medium recorded in the portable recording medium; and
a use-information recording unit configured to record, with the CPU, the ID information acquired by the ID-information acquiring unit and information for specifying an original document, which is a reading source of scan image data that should be recorded in the portable recording medium, which is an acquisition source of the ID information, in association with each other.

2. The apparatus according to claim 1, wherein the information for specifying the original document is the scan image data or data acquired from the scan image data.

3. The apparatus according to claim 1, wherein the ID information of the portable recording medium is information including a MAC address.

4. The apparatus according to claim 1, further comprising a determining unit configured to perform, on the basis of a result of processing for acquiring ID information by the ID-information acquiring unit, determination processing for determining whether recording of the scan image data in the portable recording medium should be permitted.

5. The apparatus according to claim 4, further comprising a re-determining unit configured to acquire, if the determining unit determines that the recording of the scan image data in the portable recording medium is permitted, ID information from the portable recording medium again in starting recording processing in the portable recording medium and determine, on the basis of the acquired ID information, whether recording of the scan image data in the portable recording medium should be permitted.

6. The apparatus according to claim 1, further comprising an ID-information granting unit configured to grant the ID information to the portable recording medium.

7. The apparatus according to claim 6, wherein the ID-information granting unit determines whether the ID information is granted to the portable recording medium and grants the ID information to the portable recording medium if the ID information is not granted thereto.

8. A scan image management method for managing scan image data acquired by scanning an original document, the scan image management method comprising:
acquiring, with a CPU, ID information of a portable recording medium recorded in the portable recording medium; and
recording, with the CPU, the acquired ID information and information for specifying an original document, which is a reading source of scan image data that should be recorded in the portable recording medium, which is an acquisition source of the ID information, in association with each other.

9. The method according to claim 8, wherein the information for specifying the original document is the scan image data or data acquired from the scan image data.

10. The method according to claim 8, wherein the ID information of the portable recording medium is information including a MAC address.

11. The method according to claim 8, further comprising performing, on the basis of a result of processing for acquiring ID information, determination processing for determining whether recording of the scan image data in the portable recording medium should be permitted.

12. The method according to claim 11, further comprising acquiring, if it is determined in the determination processing that the recording of the scan image data in the portable recording medium is permitted, ID information from the portable recording medium again in starting recording processing in the portable recording medium and determining, on the basis of the acquired ID information, whether recording of the scan image data in the portable recording medium should be permitted.

13. The method according to claim 8, further comprising granting the ID information to the portable recording medium.

14. The method according to claim 13, further comprising determining whether the ID information is granted to the portable recording medium and granting the ID information to the portable recording medium if the ID information is not granted thereto.

15. A computer-readable recording medium having recorded thereon a scan image management program for causing a computer to execute processing for managing scan image data acquired by scanning an original document, the scan image management program causing the computer to execute processing for:
acquiring ID information of a portable recording medium recorded in the portable recording medium; and
recording the acquired ID information and information for specifying an original document, which is a reading source of scan image data that should be recorded in the portable recording medium, which is an acquisition source of the ID information, in association with each other.

16. The recording medium according to claim 15, wherein the information for specifying the original document is the scan image data or data acquired from the scan image data.

17. The recording medium according to claim 15, wherein the ID information of the portable recording medium is information including a MAC address.

18. The recording medium according to claim 15, wherein the scan image managing program further causes the computer to execute processing for performing, on the basis of a result of processing for acquiring ID information, determination processing for determining whether recording of the scan image data in the portable recording medium should be permitted.
